(19) United States
(12) Patent Application Publication
(10) Pub. No.: US 2005/0277445 A1
(43) Pub. Date: Dec. 15, 2005

(54) Hands-free vehicle phone system and method

(76) Inventor: Hyon S. Bae, Oakland, CA (US)

Correspondence Address: MAYER, BROWN, ROWE & MAW LLP, P.O. BOX 2828, CHICAGO, IL, 60690-2828, US

(21) Appl. No.: 10/866,306

(22) Filed: Jun. 9, 2004

(51) Int. Cl. H04M 1/00

(52) U.S. Cl. 455/569.1

(57) ABSTRACT

A hands-free phone system for a vehicle is described for selecting one of a plurality of Bluetooth® enabled phones within a communication range of a Bluetooth® hands-free base.

### FIELD

The present invention generally relates to Bluetooth® enabled phones, and more particularly, to a method and system for using multiple Bluetooth® enabled phones in a hands-free phone system in a vehicle.

### BACKGROUND

Bluetooth® technology is a standard developed by Bluetooth® SIG, Inc. for local wireless communication of mobile devices, such as cellular phones, wireless headsets, computers, printers, cars, and even turn-stiles. This technology allows two Bluetooth® enabled devices within a certain proximity of each other to communicate with one other wirelessly (see, e.g., http://www.Bluetooth®.org; “Specification of the Bluetooth® System”, Covered Core Package, v.1.2, Nov. 5, 2003, incorporated herein by reference). The technology promises a variety of improvements over current wired solutions, such as hands-free communication and effortless synchronization.

In vehicles, there is a particular need to adopt a wireless solution where the hazards associated with driving and speaking on a mobile phone are significant. Conventional hands-free solutions in automobiles have enabled drivers to use their mobiles phones without hands by placing the mobile phone in a cradle that is connected to a hands-free system (typically a microphone and speakers wired together) in the automobile. These hands-free systems have been further enhanced using Bluetooth® technology that requires no cradle since the Bluetooth® phone is able to transmit data directly between the mobile phone and the hands-free system in the automobile. In these Bluetooth® hands-free systems, a driver or passenger of an automobile having a Bluetooth® enabled phone is able to automatically connect with the hands-free system in the automobile after the phone is undergoes a “pairing” procedure to identify the phone to the hands-free system the first time the phone is used with the hands-free system.

Pairing requires that the mobile phone be “identified” by the hands-free system by undergoing a first-time pairing process that typically requires a scanning of devices by the hands-free system and then an identification of each paired device that is entered into the system. Once the pairing process in performed, the mobile phone and the hands-free system automatically connect when they are within a certain proximity of one another. Hands-free systems typically allow up to four mobile phones to be paired into a hands-free system at one time.

A significant problem exists, however, when more than one Bluetooth® enabled phone is within proximate range of the hands-free system within the automobile. This is because Bluetooth® technology only allows for one phone to be connected at a time. Thus, in a scenario where there are four paired phones, for example, that are stored in the hands-free system, the first Bluetooth® enabled phone identified by the system will be the phone that can be used. Should another Bluetooth® enabled phone be needed to be connected to the hands-free system, a number of alternative actions must be taken. In one alternative, all other paired phones must be turned off, leaving on only the phone to be used so that the hands-free system recognizes only that phone. Obviously, this is a cumbersome process that requires all paired phones to be turned off and later turned on again. A second alternative is that some Bluetooth® hands-free systems prioritize the phones paired into the system. Thus, for example, in the BMW® Universal Bluetooth® Hands-Free System manufactured by BMW® of North America, LLC, the phone paired last has the highest priority. If two phones enter the hands-free system simultaneously, only the phone with the highest priority will be able to use the hands-free function for incoming and outgoing calls. Again, this second alternative has a drawback that a phone having lower priority cannot be used until all higher priority phones are turned off or go outside the range of the Bluetooth® technology.

A need therefore exists for a hands-free, Bluetooth® system without these limitations.

### SUMMARY OF THE INVENTION

An embodiment of the present invention includes a Bluetooth® hands-free phone system for a vehicle. In the Bluetooth® hands-free phone system, a plurality of Bluetooth® enabled phones are brought within a communication range of a Bluetooth® hands-free base within a vehicle. The Bluetooth® hands-free phone system includes the Bluetooth® hands-free base in communication with each of the plurality of the Bluetooth® enabled phones, and in communication with a speaker, and a microphone, all within a vehicle. The Bluetooth® hands-free base further includes a selection mechanism that provides identification information for identifying each of the plurality of Bluetooth® enabled phones within the communication range and allows a selection of any one of the plurality of Bluetooth® enabled phones identified to be connected to the Bluetooth® hands-free base and the hands-free system.

A method is further described for selecting one of a plurality of Bluetooth® enabled phones in a vehicle for use in a hands-free phone system. The method includes first providing the hands-free phone system within the vehicle that includes the plurality of Bluetooth® enabled phones, the Bluetooth® hands-free base, a microphone to send voice communication to the Bluetooth® hands-free base and a speaker to receive voice communication from the Bluetooth® hands-free base. Each of the Bluetooth® enabled phones are within a communication range of the Bluetooth® hands-free base. The method further includes identifying, by the Bluetooth® hands-free base, each of the plurality of the Bluetooth® enabled phones within the communication range where each of the plurality of the Bluetooth® enabled phones are identified by an identification information. The identification information is then communicated to a passenger or driver within the vehicle, for permitting a selection of one of the plurality of Bluetooth® enabled phones to be used in the hands-free system. The one of the plurality of Bluetooth® enabled phones is selected to be connected to the hands-free system by selecting the identification information for one of the plurality of the Bluetooth® enabled phones.

### BRIEF DESCRIPTION OF THE DRAWINGS

A more complex appreciation of the invention and many of the advantages thereof will be readily obtained as the same becomes better understood by references to the detailed description when considered in connection with the accompanying drawings, wherein:

FIG. 1 is a block diagram view of an embodiment of the hands-free phone system of the present invention shown within a vehicle;

FIG. 2 is a schematic diagram view of an embodiment of the Bluetooth® hands-free base in communication with an embodiment of the hands-free phone system of the present invention;

FIG. 3 is a further schematic diagram view of an embodiment of the Bluetooth® hands-free base in communication with an embodiment of the a hands-free phone system of the present invention;

FIG. 4 is a schematic diagram view of the Bluetooth® hands-free base in communication with a plurality of Bluetooth® enabled phones;

FIG. 5 is a schematic diagram view of the internal components of the Bluetooth® hands-free base in communication with the hands-free phone system of the present invention;

FIG. 6 is a flow diagram view of an embodiment of the methodology of the present invention; and

FIG. 7 is a block diagram view of a computer system used to perform an embodiment of the methodology of the present invention.

### DETAILED DESCRIPTION

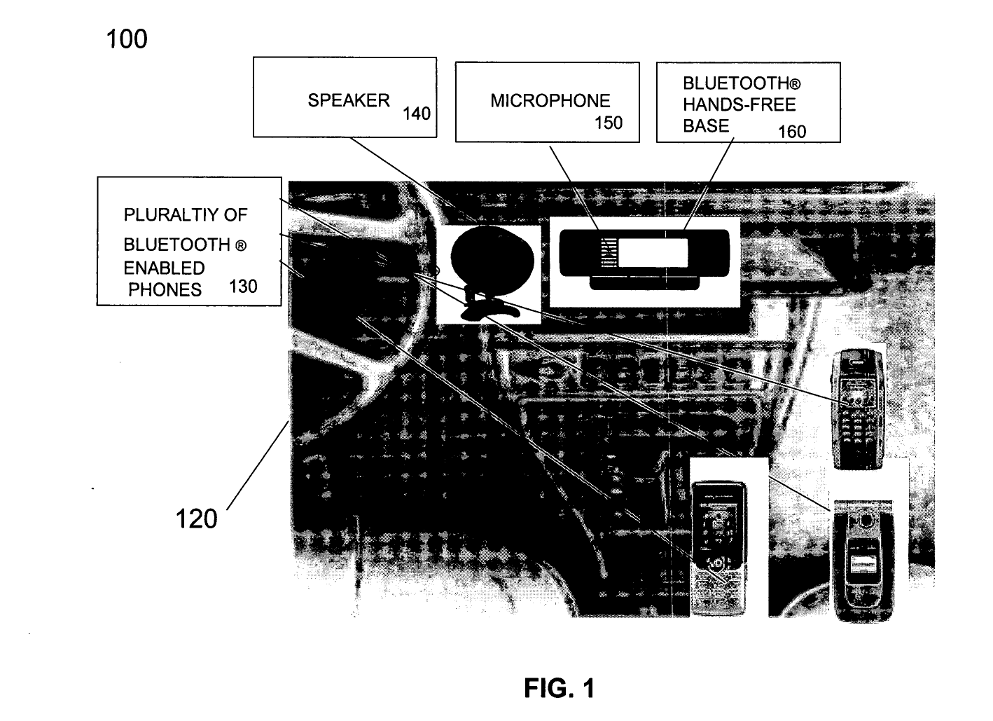

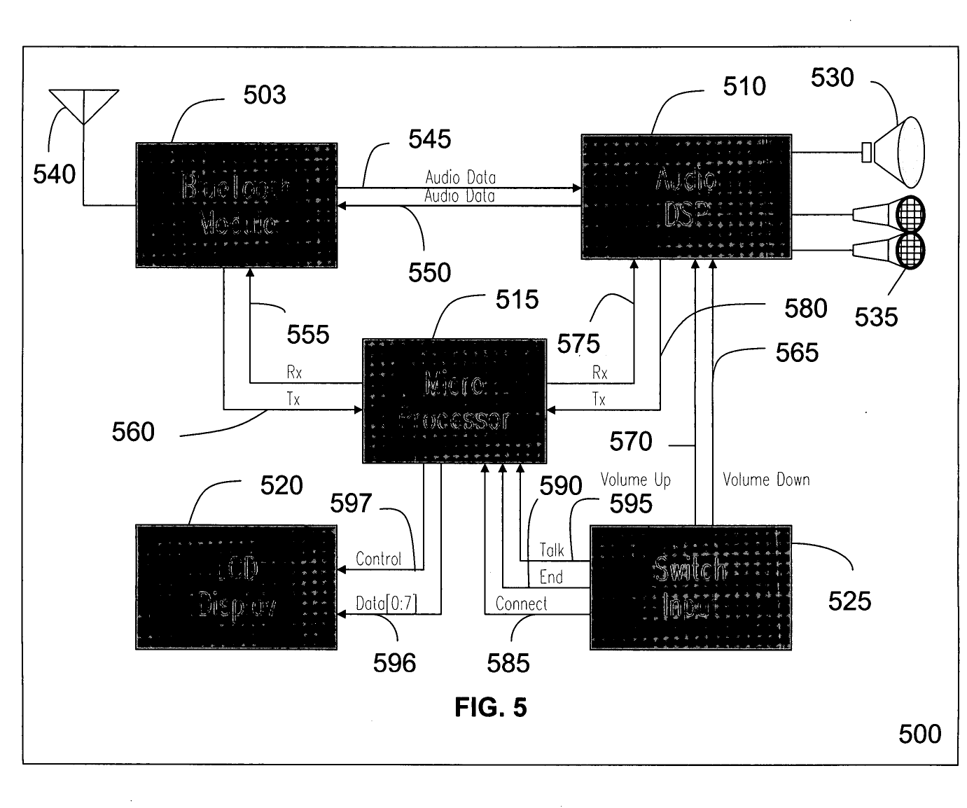

FIG. 1 is a schematic diagram view of an embodiment of the hands-free phone system of the present invention. In FIG. 1, the embodiment of the hands-free phone system 100 includes a plurality of Bluetooth® enabled phones 130, a speaker 140, a microphone 150 and a Bluetooth® hands-free base 160. All these components of the hands-free system 100 are found within a vehicle 120, in this embodiment. The hands-free phone system 100 relies on Bluetooth® technology that is incorporated in both the Bluetooth® hands-free base 160 and each of the plurality of Bluetooth® enabled phones 130. Bluetooth® technology is a well known standard for local wireless communication of mobile devices, such as the plurality of Bluetooth® enabled phones 130. The Bluetooth® specification is publicly available at http://www.Bluetooth®.org titled “Specification of the Bluetooth® System”, Covered Core Package, v.1.2, Nov. 5, 2003, incorporated herein by reference. There is also available a “Hands-Free Profile,” Adopted Version 1.0, dated Apr. 29, 2003 that is published by the Bluetooth® SIG, Inc., providing protocols on procedures in implementing a Hands-Free Profile, incorporated herein by reference (both the Hands-Free Profile and the Specification of the Bluetooth® System are referred to as the “Bluetooth® Specification”). These plurality of Bluetooth® enabled phones 130 are able to communicate with other Bluetooth® enabled devices, such as the Bluetooth® hands-free base 160, whenever the plurality of Bluetooth® enabled phones 130 are within a communication range of the Bluetooth® hands-free base 160. Typically, as described in the Bluetooth® Specification, this communication range is approximately 10 meters (or 32.8 feet). As generally described in the Bluetooth® Specification, whenever any of the plurality of the Bluetooth® enabled phones 130 are within the communication range of the Bluetooth® hands-free base 160, the Bluetooth® hands-free base 160 establishes a wireless communication with each of the plurality of Bluetooth® enabled phones 130, after a process known as “pairing” is performed. However, unlike the current Bluetooth® Specification, which can only sustain a single communication link with a single phone at any one time, the Bluetooth® hands-free base 160 provides a selection mechanism (described below) that permits any one of the plurality of Bluetooth® enabled phones 130 to be selectively chosen to establish a connection with the Bluetooth® hands-free base 160 and thereby with the hands-free phone system 100 within the vehicle 120. Each of the plurality of the Bluetooth® enabled phones 130 contains a Bluetooth® module (FIG. 5) that contains the Bluetooth® technology for wireless communication described in the Bluetooth® Specification above. Any mobile phone that contains the Bluetooth® wireless communication module (FIG. 5) may be used. In one embodiment, the Bluetooth® enabled phone is a Nokia 6310 model manufactured by Nokia Corporation. Similarly, the Bluetooth® hands-free base 160 also contains the ability to communication through Bluetooth® technology, and also contains a Bluetooth® module (FIG. 5). All the embodiments shown in FIG. 1 show the Bluetooth® hands-free base 160 as a separate device contained within the vehicle 120. It is understood that the Bluetooth® hands-free base 160 may be any Bluetooth® enabled electronic device that is able to communication with a passenger or driver of the vehicle 120, either through visual communication signals such as a display device, or through audible communication signals such as audio signals through a speaker, in another embodiment. Thus, the Bluetooth® hands-free base 160 may be, in one embodiment, a voice-activated device that allows a passenger or driver to select one of the plurality of Bluetooth® enabled phones that are within the communication range and allow voice selection or manual selection of that Bluetooth® enabled phone through the Bluetooth® hands-free base 160. In another embodiment, the Bluetooth® hands-free base 160 is a separate device found within the vehicle 120 that is able to communication with the plurality of Bluetooth® enabled phones 130. In one embodiment, the Bluetooth® hands-free base 160 is wired by conventional wires into the vehicle 120 and also wired to the speaker 140 and the microphone 150. In this manner, the Bluetooth® hands-free base 160 is able to provide communication signals from a passenger or driver in the vehicle 120 through the microphone 150 that is electronically connected to the Bluetooth® hands-free base 160 and through the Bluetooth® enabled phone 130. From the Bluetooth® enabled phone 130, the electronic signal is then transmitted by the Bluetooth® enabled phone 130 outside of the vehicle 120 using well-known cellular or satellite technologies. The speaker 140, in one embodiment, is any conventional audio speaker used within a vehicle. In another embodiment, the speaker 140 is the speaker integrated into a vehicle 120 that is used by an integrated audio system within a vehicle. In an alternative embodiment, the speaker 140 may be any portable (i.e. non-integrated) speaker that may be placed within the vehicle 120 and electronically connected to the Bluetooth® hands-free base 160. The microphone 150, much like the speaker 140, may be any conventional microphone that is able to receive voice signals from a passenger or driver within the vehicle 120 and transmit those electrical signals to another device, such as the Bluetooth® hands-free base 160. The microphone 150 may be integrated into the vehicle 120 or may be a portable microphone. In another embodiment, all the components of the hands-free system within the vehicle 120, including the speaker 140, the microphone 150 and the Bluetooth® hands-free base 160, are able to communicate wirelessly, rather than being hard-wired together within the vehicle 120. It is further understood that the Bluetooth® hands-free base 160 may be, in another embodiment, integrated as part of another device already within the vehicle 120, such as a vehicle radio or a vehicle global positioning satellite navigation system, as both are commonly known in the art. The Bluetooth® hands-free base 160 may also be a part of other electrical components within the vehicle 120 that is able to communicate, either through a display device or through audio signals, with the passenger/driver within the vehicle 120. These electrical components could include any of the displays for speed, vehicle maintenance, time or other components typically displayed on the vehicle dashboard or elsewhere within a vehicle.

In operation, each of the plurality of Bluetooth® enabled phones 130 must first undergo a process known as “pairing” as is generally described in the Bluetooth® Specification. Generally, the pairing process is used to identify each of the plurality of Bluetooth® enabled phones 130 by the Bluetooth® hands-free base 160. The pairing procedures are typically performed only once for each new phone introduced into the hands-free phone system 100. Once the Bluetooth® enabled phone 130 is paired with the Bluetooth® hands-free base 160, the Bluetooth® hands-free base 160 is able to identify each of the plurality of Bluetooth® enabled phones 130 whenever any one of those phones 130 are within the communication range of the Bluetooth® hands-free base (typically about 30-40 feet). This identification is automatic and typically occurs when the Bluetooth® enabled phones 130 are within the range and the ignition of the vehicle 120 is turned on. The pairing thus enables the Bluetooth® hands-free base 160 to receive identification information for each of the plurality of Bluetooth® enabled phones 130 so as to list each of the Bluetooth® enabled phones 130 (that have been paired) on a display device of the Bluetooth® hands-free base 160. In one embodiment, the Bluetooth® Specification provides for about eight (8) different Bluetooth® enabled phones 130 to be listed or stored in the Bluetooth® hands-free base 160. Should any additional phones need to be paired with the Bluetooth® hands-free base 160, other phones and their corresponding identification information will be deleted from the Bluetooth® hands-free base 160 to make room for the additional phones. Thus, in this embodiment, the Bluetooth® hands-free base 160 has a display screen (described below) that displays a list of the identification information for each of the Bluetooth® enabled phones 130. The identification information may be any information that uniquely identifies each of the plurality of Bluetooth® enabled phones 130. In one embodiment, the identification information is the device identification provided by a manufacturer for each phone. In an alternative embodiment, the identification information may be any information that uniquely identifies each of the plurality of Bluetooth® enabled phones 130. For example, the identification information may be a unique phone number, serial number, or other manner of identifying each of the plurality of Bluetooth® enabled phones 130 that will be paired. In addition, the Bluetooth® hands-free base 160 allows, in alternative embodiments, for each of the Bluetooth® enabled phones 130 to be uniquely named by user.

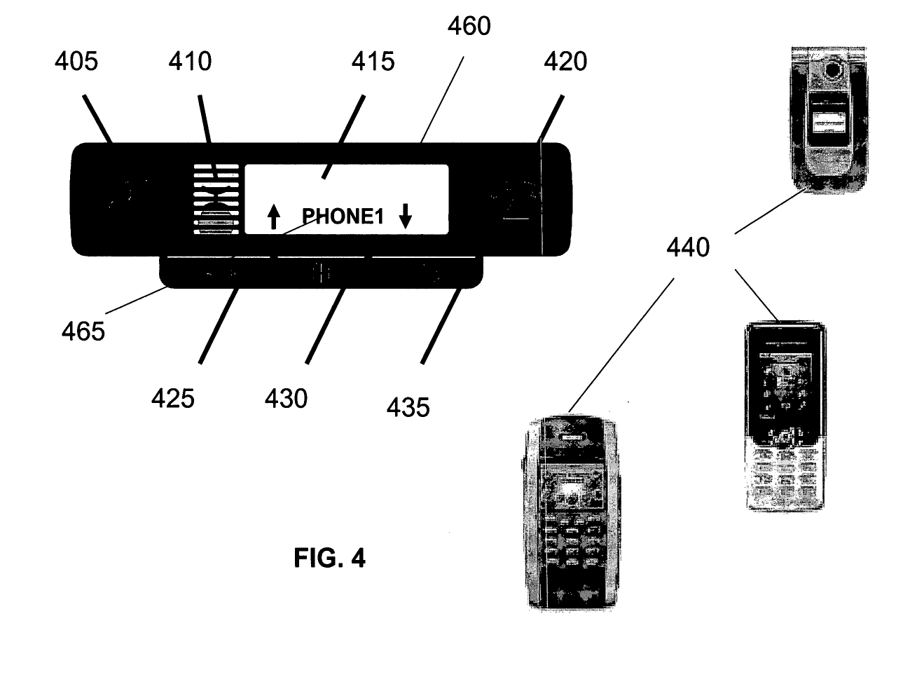

Continuing in the operation of the hands-free phone system 100 of FIG. 1, each of the plurality of Bluetooth® enabled phones 130 have been paired with the Bluetooth® hands-free base 160 and the identification information (that uniquely identifies each of the plurality of Bluetooth® enabled phones 130 within the communication range) have been entered into the Bluetooth® hands-free base 160. It is noted that the pairing procedure and other procedures for Bluetooth® communication between the devices is already a standard in the Bluetooth® Specification, thus no additional configuration must be done in order to permit the pairing or Bluetooth® communication. Thus, the hands-free phone system 100 of the present invention uniquely benefits from ease of use of the standard protocol of the Bluetooth® technology. Moreover, this embodiment of the present invention further adds the unique ability of a selection mechanism (shown below) found on the Bluetooth® hands-free base 160 that allows the selection of any one of the plurality of Bluetooth® enabled phones 130 identified to be connected to the Bluetooth® hands-free base 160. This selection is performed by interfacing with the Bluetooth® hands-free base 160, either through a manual interaction or audio interface, to select one of the identification information and thereby make a connection with one of the plurality of Bluetooth® enabled phones 130. Thus, the Bluetooth® Specification only provides for the first Bluetooth® enabled phone identified by the hands-free phone system to be automatically connected to the hands-free system. In contrast, the hands-free system 100 uniquely allows any one of the Bluetooth® enabled phones 130 to be paired with the Bluetooth® hands-free base 160 and to be selected and conveniently connected to the hands-free phone system 100. This provides the tremendous advantage of not having to turn off all the Bluetooth® enabled phones 130 that are currently paired to the Bluetooth® hands-free base except for the one phone that wishes to be connected. In the past, this was the only manner available to select any one of the plurality of Bluetooth® enabled phones to be connected to the hands-free system. Now, a passenger or driver within the vehicle may select any one of plurality of Bluetooth® enabled phones 130 through the Bluetooth® hands-free base 160. If the Bluetooth® hands-free base 160 contains a display screen, the user is typically able to select the identification information (corresponding to the Bluetooth® enabled phone 130 that it wishes to connect to) by manually selecting (through, for example, pressing a button mechanism) the Bluetooth® enabled phone 130 that the user wishes to connect to. This is because the identification information that corresponds to each of the plurality of Bluetooth® enabled phones 130 that have been paired with the Bluetooth® hands-free base 160 may be reviewed through any type of manual selection mechanism, such as a button, or a scrolling mechanism, that permits all the identification information to be viewed for each of the plurality of the Bluetooth® enabled phones 130. Through a scrolling mechanism (FIG. 4), a user may scroll through the list of identification information to select a Bluetooth® enabled phone 130. A user would therefore scroll through the list of identification information for each of plurality of Bluetooth® enabled phones 130 and select a phone that it wishes to connect to through the hands-free phone system 100. In other embodiments, the selection mechanism may be found on buttons anywhere in the vehicle (e.g. on a steering wheel) so that identification information may be selected from various locations in the vehicle. In alternative embodiments, rather than manually interfacing with the Bluetooth® hands-free base 160, a user may provide voice-activated communication signals through the hands-free system (e.g. through the speaker 140 and microphone 150) in order to select the identification information for the Bluetooth® enabled phone 130 that the user wishes to connect to. Using voice-activation, the hands-free system 100 would audibly (through the speakers 140) pronounce the identification information within the vehicle and the user (passenger/driver) would respond, either through voice responses into the microphone, or by manual input through the scrolling, connecting and other button mechanisms. It is further understood that the selection mechanisms may be portable or integrated into the vehicle. For example, a portable selection mechanism may be a stand-alone Bluetooth® enabled base that is manually carried into a vehicle. In a still further embodiment, any one of the plurality of Bluetooth® enabled phones 130 could be used to select the identification information remotely. In this embodiment, the phone 130 would transmit signals to the base 160 to select the identification information. It is further understood that the identification information may also be any device identification number that is assigned to each device model. Once a user selects the identification information and is connected to hands-free phone system, the user is able to communicate with the hands-free phone system through the microphone 150 and speaker 140 combination and use the Bluetooth® enabled phone 130 to communicate outside of the vehicle, as it is well known in the art.

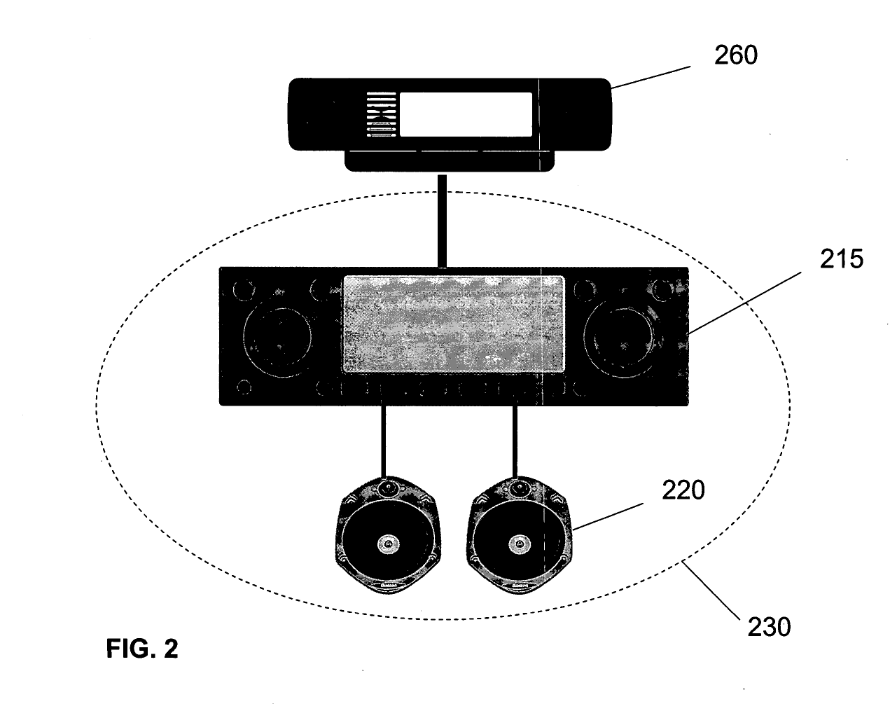

FIG. 2 is a schematic diagram view of an embodiment of the hands-free system of the present invention. In FIG. 2, the hands-free base 260 is in communication with a vehicle audio system 230 that has already been integrated into a vehicle (not shown). By communication, it is understood that the base transmits data and voice signals with the phones. In this way, any of the personal data stored on the phone 130 may be communicated to the base 160. Such personal data may include the address book and phone numbers stored on the phones, or other data. The embodiment of FIG. 2 has significant advantages since the Bluetooth® hands-free base 260 may be purchased after a vehicle is purchased and easily connected to a vehicle that has not been equipped originally with the Bluetooth® hands-free base 260. In this way, the Bluetooth® hands-free base 260 is able to use the electrical connections between the vehicle radio 215 and the speakers 220 that are already a part of the vehicle audio system 230. While the embodiment of FIG. 2 shows a hard wired connection between the Bluetooth® hands-free base 260 and the vehicle radio 215, it is understood that the Bluetooth® hands-free base 260 may also be wirelessly connected to any integrated audio system in alternative embodiments.

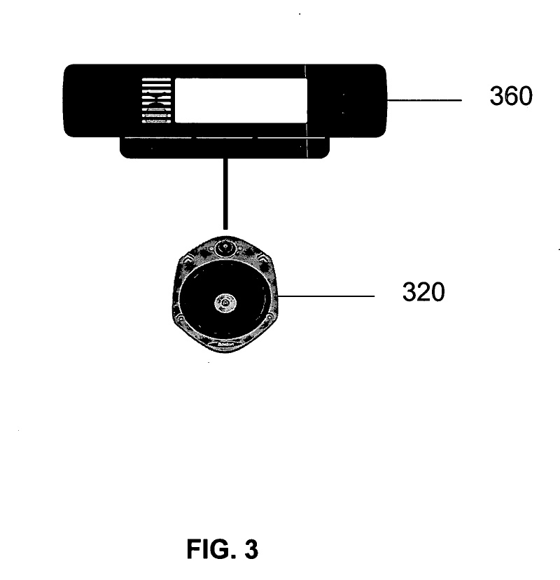

FIG. 3 is a schematic diagram view of a still further embodiment of the hands-free system of the present invention. In FIG. 3, the Bluetooth® hands-free base 360 is connected directly with a speaker 320 and not through an audio system already integrated into a vehicle as in FIG. 2. In this embodiment, the Bluetooth® hands-free base 360 may be sold separately with its own speaker 320 and microphone (not shown) system and placed into a vehicle as a stand alone hands-free phone system. Also, this embodiment is portable and may therefore be used in multiple vehicles.

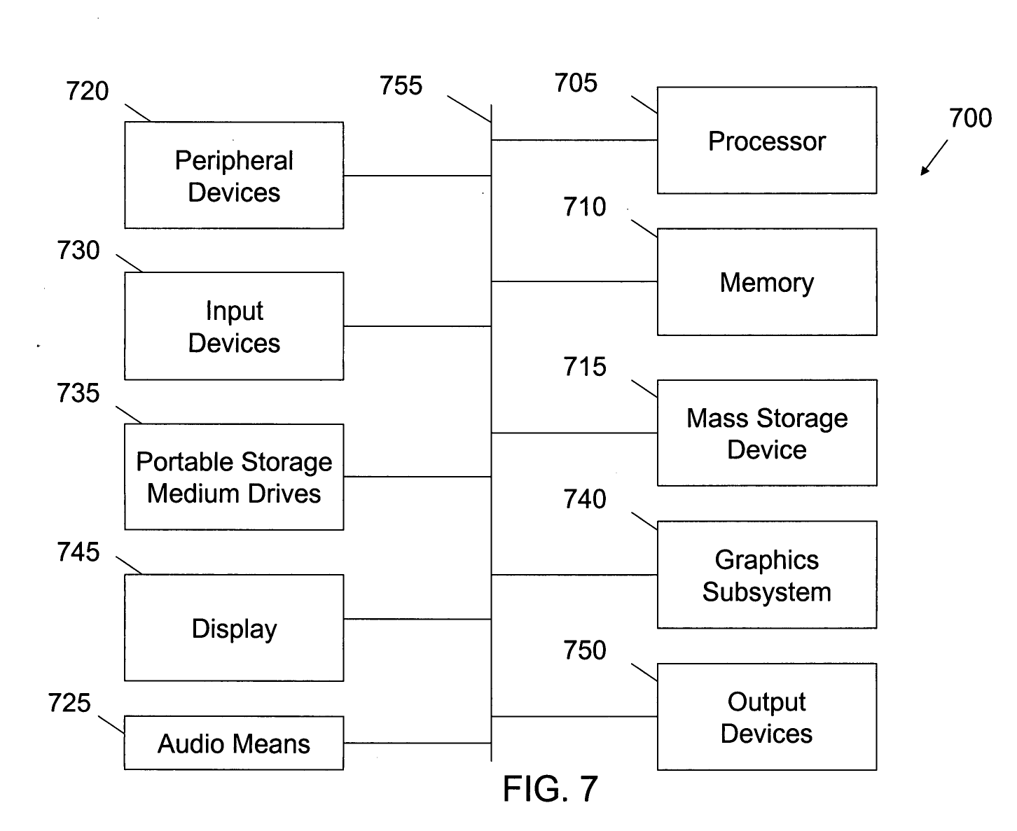

FIG. 4 is a schematic diagram view of the hands-free base in communication with a plurality of Bluetooth® enabled phones. In FIG. 4, an embodiment of the Bluetooth® hands-free base 460 is shown. In this embodiment, the Bluetooth® hands-free base 460 has selection mechanisms in the form of manual buttons including scrolling-up button 425, connecting button 430, and scrolling down button 435. A display screen 415, a microphone 410, an end button 420, and a send button 405 complete the selection mechanisms of the Bluetooth® hands-free base 460 in this embodiment. The send button 405 allows the transmission of commands to the base 460. Also shown in FIG. 4 are the plurality of Bluetooth® enabled phones 440 that are within the communication range of the Bluetooth® hands-free base 460 shown. In this embodiment, the display screen 415 may be any display that is capable of providing some type of user interface to a passenger or driver in the vehicle. In this embodiment, the display screen visually provides the identification information that uniquely identifies each of the plurality of Bluetooth® enabled phones 440 that have been previously paired to the Bluetooth® hands-free base 460 as described above. In one embodiment, the display screen is a liquid crystal display (LCD) device. Alternative display screen embodiments are described with regard to FIG. 7 below. In one embodiment, the display screen 415, which showed eight (8) separate identification information, corresponds to eight (8) different Bluetooth® enabled phones 440. In use of the embodiment shown in FIG. 4, a passenger or driver within a vehicle wishes to connect to one of the plurality of Bluetooth® enabled phones 440 that are within the communication range of the vehicle. That passenger or driver scrolls the display screen 415 by using the scrolling-up button 425 or scrolling down button 435 to locate the identification information that corresponds to the Bluetooth® enabled phone 440 that the passenger or driver wishes to connect to the hands-free system. Once the identification information is found, the passenger or driver presses the connecting button 430 and the Bluetooth® hands-free base 460 connects the Bluetooth® enabled phone 440 that corresponds to the identification information to the hands-free system. In this embodiment, the identification information is “phone1” 465, however, in other embodiments, the identification information may be a name, device identification number, model, manufacturer or other uniquely identifying information. It is further understood that the vehicle may be any automobile, truck, van, tractor or other vehicle.

FIG. 5 is a block diagram view of the internal components of an embodiment of the Bluetooth® hands-free base of the present invention. In FIG. 5, a number of components are found within the Bluetooth® hands-free base, including a Bluetooth® module 503, an audio DSP 510, a microprocessor 515, a LCD display 520 and a switch input 525. In this embodiment, the Bluetooth® module 503 is the hardware and software that is set forth in the Bluetooth® Specification that enables any electrical device equipped with the Bluetooth® module 503 to communication with other Bluetooth® enabled devices. This communication is done through the Bluetooth® antenna 540 which transmits signals with the Bluetooth® enabled phones (not shown). The Bluetooth® module 503 communicates audio/data signals through communication lines 545 and 550 with the audio DSP 510. These communication lines are, in one embodiment, wires. The audio DSP (digital signal processor) receives the audio data from the Bluetooth® module as well as further information from the switch input 525 and the microprocessor 515 in order to transmit audio signals to and from the Bluetooth® hands-free base 500, the speakers 535, and microphone 530. The audio DSP 510 is electrically connected to the microprocessor 515 and the switch input 525 through communication wires 575, 580, 565 and 570. The communication wires 565 (volume down) and 570 (volume up) allow the volume to be controlled on the Bluetooth® hands-free base 500. The switch input 525 works with microprocessor 515 to deliver electrical pulses corresponding to the selection mechanisms (talk, end, connect) to the microprocessor depending on which selection mechanism is entered by a passenger or driver. The microprocessor 515 then works with the display screen 520 through lines 597 and 596 in order to display any data such as the identification information to a passenger or driver. It is understood that this is one embodiment of a Bluetooth® hands-free base and that other embodiments, for example, may contain devices for voice-activated interaction rather than display screen interaction with a passenger or driver.

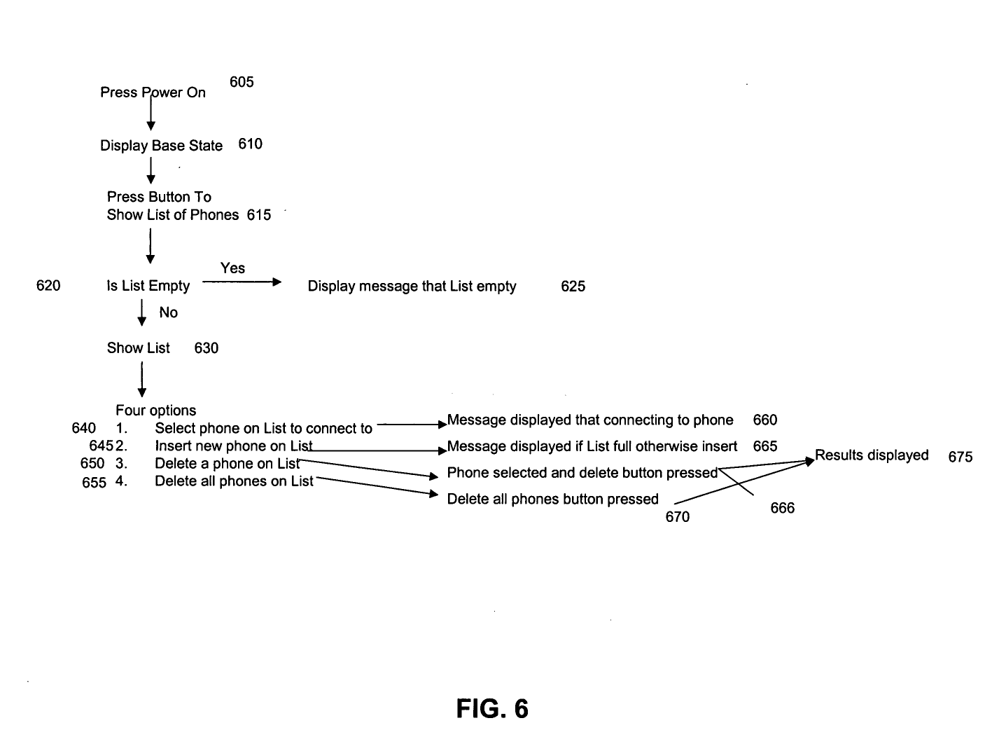

FIG. 6 is a flow diagram view of an embodiment of the methodology of the present invention. In FIG. 6, the hands-free phone system begins by pressing power on at step 605 or turning on the ignition key of a vehicle. At that point, the Bluetooth® hands-free base is turned on and automatically detects all Bluetooth® enabled phones that have been paired with the Bluetooth® hands-free base and lists the identification information on a display screen of the Bluetooth® hands-free base, in one embodiment. Thus, at step 610, the identification information is displayed on the Bluetooth® hands-free base screen as the base state. A driver or passenger in the vehicle that wishes to make a hands-free phone system connection to a specific Bluetooth® enabled phone that is within the communication range begins by pressing the scrolling-up button or the scrolling-down button of the selection mechanism on the Bluetooth® hands-free base to move the list of phones on the display screen up or down to locate the identification information corresponding to the Bluetooth® enabled phone that the user wishes to connect the hands-free phone system to. If the list is empty at 620, the display screen at 625 shows a message that the list is empty and thereby requires the passenger or driver to pair the Bluetooth® enabled phones to the Bluetooth® hands-free base. If the list is not empty at step 630, the list of identification information corresponding to the plurality of Bluetooth® enabled phones is shown. At this point, the passenger or driver has a number of options. At step 640, the phone can be selected using the selection mechanism to scroll through the list to connect to the identification information corresponding to the Bluetooth® enabled phones. Once the identification information for the phone desired is located, the user presses the connect button and a message is displayed that the Bluetooth® hands-free base is connecting to the phone at step 650. Another option is at step 645 where the Bluetooth® hands-free base permits a user to insert a new phone onto the list. The Bluetooth® enabled phone is inserted using the pairing described above, unless a message is displayed that the list is full at step 665. At step 650, the user also has an option to delete a phone from the list by using the selection mechanisms to select a phone and then pushing a delete button at step 666. The user also has the option at step 655 to delete all phones on the list by pushing a delete all phones button at step 670. After either the delete button is pressed for a single a phone or a delete all phones button is pressed, the results of the deletion are displayed at step 675 on the screen.

It is understood that the methodology of the present invention that permits a user to use the selection mechanism to select one of the plurality of Bluetooth® enabled phones 130 may be contained in a software module that is contained within a computer-readable medium in the Bluetooth® hands-free base or is in communication with the base. In one embodiment, a software module with this methodology is written in a programming language such a Java, C, C++, or Visual Basic, as is well known in the art. Such a software module permits the methodology of selecting one of the plurality of Bluetooth® enabled phones to be connected to the hands-free system by selecting the identification information of one of the plurality of Bluetooth® enabled phones communicated. This software module would be contained on any computer readable medium as described more fully in the computer system of FIG. 7.

FIG. 7 is a block diagram of a computer system 700 used for performing an embodiment of the present invention. In one embodiment, the computer system is the Bluetooth® hands-free base. In alternative embodiments, the computer system may be a vehicle radio, a vehicle global positioning satellite navigation system or other vehicle electrical component. The computer system 700 includes a processor 730 for executing program instructions stored in a memory 725. In some embodiments, processor 730 includes a single microprocessor, while in others, processor 730 includes a plurality of microprocessors to define a multi-processor system. The memory 725 stores instructions and data for execution by processor 730, including instructions and data for performing the methods described above. Depending on the extent of software implementation in computer system 700, the memory 725 stores executable code when in operation. The memory 725 includes, for example, banks of read-only memory (ROM), dynamic random access memory (DRAM) as well as high-speed cache memory.

Still in FIG. 7, within computer system 700, an operating system comprises program instruction sequences that provide services for accessing, communicating with, and controlling the computer system 700. The operating system provides a software platform upon which application programs may execute, in a manner readily understood by those skilled in the art. The computer system 700 further comprises one or more applications having program instruction sequences for selecting one of a plurality of Bluetooth® enabled phones.

Further in FIG. 7, the computer system 700 incorporates any combination of additional devices. These include, but are not limited to, a mass storage device 735, one or more peripheral devices 740, an audio means 750, one or more input devices 755, one or more portable storage medium drives 770, a graphics subsystem 780, a display 785, and one or more output devices 745. The various components are connected via an appropriate bus 780 as known by those skilled in the art. In alternative embodiments, the components are connected through other communications media known in the art. In one example, processor 730 and memory 725 are connected via a local microprocessor bus; while mass storage device 735, peripheral devices 740, portable storage medium drives 770, and graphics subsystem 780 are connected via one or more input/output buses.

Continuing in FIG. 7, mass storage device 735 is implemented as fixed and/or removable medium, for example, as a magnetic, optical, or magneto-optical disk drive. The drive is preferably a non-volatile storage device for storing data and instructions for use by processor 730. In some embodiments, mass storage device 735 stores client and server information, code for carrying out methods in accordance with exemplary embodiments of the invention, and computer instructions for processor 730. In other embodiments, computer instructions for performing methods in accordance with exemplary embodiments of the invention also are stored in processor 730. The computer instructions are programmed in a suitable language such as Java, C or C++.

In FIG. 7, the portable storage medium drive 770, in some embodiments, operates in conjunction with a portable non-volatile storage medium, such as a floppy disk, CD-ROM, or other computer-readable medium, to input and output data and code to and from the computer system 700. In some embodiments, methods performed in accordance with exemplary embodiments of the invention are implemented using computer instructions that are stored on such a portable medium and input to the computer system 700 via portable storage medium drive 770.

In FIG. 7, the peripheral devices 740 include any type of computer support device, such as an input/output (I/O) interface, to add functionality to computer system 700. The peripheral devices also include input devices to provide a portion of a user interface and may include an alphanumeric keypad or a pointing device such as a mouse, a trackball, a stylus, or cursor direction keys. The I/O interface comprises conventional circuitry for controlling input devices and performing particular signal conversions upon I/O data. The I/O interface may include, for example, a keyboard controller, a serial port controller, and/or digital signal processing circuitry.

In FIG. 7, the graphics subsystem 780 and the display 785 provide output alternatives of the system. The graphics subsystem 780 and display 785 include conventional circuitry for operating upon and outputting data to be displayed, where such circuitry preferably includes a graphics processor, a frame buffer, and display driving circuitry. The display 785 may include a cathode ray tube (CRT) display, a liquid crystal display (LCD), or other suitable devices. The display 785 preferably can display at least 257 colors. In one embodiment, the display screen of the Bluetooth® hands-free base is an LCD screen. The graphics subsystem 780 receives textual and graphical information and processes the information for output to the display 785. The display would be used to display the GUI of FIG. 5. A video card in the computer system 700 also comprises a part of graphics subsystem 780 and also preferably supports at least 257 colors. For optimal results in viewing digital images, the user should use a video card and monitor that can display the True Color (24 bit color) setting. This setting enables the user to view digital images with photographic image quality.

In FIG. 7, audio means 750 preferably includes a sound card that receives audio signals from a peripheral microphone. In addition, audio means 750 may include a processor for processing sound. The signals can be processed by the processor in audio means 750 of computer system 700 and passed to other devices as, for example, streaming audio signals.

In some embodiments, programs for performing methods in accordance with exemplary embodiments of the invention are embodied as computer program products/mediums. These generally include a storage medium or medium having instructions stored thereon used to program a computer to perform the methods described above. Examples of suitable storage medium or media include any type of disk including floppy disks, optical disks, DVDs, CD ROMs, magnetic optical disks, RAMs, EPROMs, EEPROMs, magnetic or optical cards, hard disk, flash card, smart card, and other medium.

Stored on one or more of the computer readable medium, the program includes software for controlling both the hardware of a general purpose or specialized computer or microprocessor. This software also enables the computer or microprocessor to interact with a human or other mechanism utilizing the results of exemplary embodiments of the invention. Such software includes, but is not limited to, device drivers, operating systems and user applications. Preferably, such computer readable medium further includes software for performing the methods described above.

In certain other embodiments, a program for performing an exemplary method of the invention or an aspect thereof is situated on a carrier wave such as an electronic signal transferred over a data network. Suitable networks include the Internet, a frame relay network, an ATM network, a wide area network (WAN), or a local area network (LAN). Those skilled in the art will recognize that merely transferring the program over the network, rather than executing the program on a computer system or other device, does not avoid the scope of the invention.

It will be understood that the above-described apparatus and the method therefrom are merely illustrative of applications of the principles of this invention and many other embodiments and modifications may be made without departing from the spirit and scope of the invention as defined in the claims.

1. A hands-free phone system for a vehicle, comprising:
a plurality of Bluetooth® enabled phones, each of the plurality of Bluetooth® enabled phones being within a communication range of a Bluetooth® hands-free base in the vehicle;
the Bluetooth® hands-free base in communication with each of the plurality of Bluetooth® enabled phones, the Bluetooth® hands-free base transmitting communication signals among the Bluetooth® enabled phones, a speaker and a microphone, the Bluetooth® hands-free base further comprising:
a selection mechanism, the selection mechanism providing an identification information for identifying each of the plurality of Bluetooth® enabled phones within the communication range and allowing selection of any one of the plurality of Bluetooth® enabled phones identified to be connected to the Bluetooth® hands-free base;
the microphone in communication with the Bluetooth® hands-free base to send voice communication to the Bluetooth® enabled phone through the Bluetooth® hands-free base; and
the speaker in communication with the Bluetooth® hands-free base to receive voice communication from the Bluetooth® enabled phone through the Bluetooth® hands-free base.

2. The system of claim 1, wherein the selection mechanism further comprises:
a display screen, the display screen displaying the identification information for identifying each of the plurality of Bluetooth® enabled phones within the communication range.

3. The system of claim 2, wherein the identification information is a device identification number of each of the plurality of Bluetooth® enabled phones.

4. The system of claim 2, wherein the Bluetooth® hands-free base further comprises a button mechanism for selecting the identification information displayed on the screen for the Bluetooth® enabled phone to be selected.

5. The system of claim 2, wherein the Bluetooth® hands-free base further comprises a scrolling mechanism for scrolling through the identification information for the plurality of Bluetooth® enabled phones.

6. The system of claim 1, wherein the Bluetooth® hands-free base further comprises a connect mechanism to initiate a connection of the Bluetooth® hands-free base to one of the plurality of Bluetooth® enabled phones.

7. The system of claim 1, wherein the Bluetooth® hands-free base is integrated with a vehicle radio.

8. The system of claim 1, wherein the Bluetooth® hands-free base is integrated with a vehicle global positioning satellite navigation system.

9. The system of claim 1, wherein the Bluetooth® hands-free base is integrated with another electrical component within the vehicle.

10. The system of claim 1, wherein the selection mechanism is integrated in a steering wheel of the vehicle.

11. The system of claim 1, wherein the selection mechanism is voice-activated.

12. The system of claim 1, wherein the selection mechanism is a portable selection mechanism.

13. The system of claim 1, wherein the selection mechanism is integrated into the vehicle.

14. The system of claim 1, wherein the selection mechanism allows selection of one of the plurality of Bluetooth® enabled phones remotely from the one of the plurality of Bluetooth® enabled phones selected.

15. The system of claim 1, wherein the communication range is a range of about 30 to 40 feet.

16. The system of claim 1, wherein the Bluetooth® hands-free base is in communication with a Bluetooth® antennae to communicate with the plurality of Bluetooth® enabled phones.

17. The system of claim 1, wherein the communication signals are voice signals.

18. The system of claim 1, wherein the communication signals are data signals.

19. The system of claim 18, wherein the data signals transfer a personal data between each of the plurality of Bluetooth® enabled devices and the Bluetooth® hands-free base.

20. The system of claim 19, wherein the personal data includes an address or phone number.

21. The system of claim 1, wherein the selection mechanism further comprises:
a voice-activated selection mechanism, the voice-activated selection mechanism communicating through voice signals the identification information for identifying each of the plurality of Bluetooth® enabled phones within the communication range and allowing voice selection or manual selection.

22. The system of claim 1, wherein the speaker, the microphone, and the Bluetooth® hands-free base communicate through wires.

23. The system of claim 1, wherein the speaker, the microphone, and the communication base communicate wirelessly.

24. The system of claim 1, wherein the display screen is a liquid crystal display screen.

25. A method for selecting one of a plurality of Bluetooth® enabled phones in a vehicle for use in a hands-free phone system, comprising:
providing the hands-free phone system within the vehicle, the hands-free phone system having the plurality of Bluetooth® enabled phones, the Bluetooth® hands-free base, a microphone to send voice communication to the Bluetooth® hands-free base and a speaker to receive voice communication from the Bluetooth® hands-free base, each of the Bluetooth® enabled phones being within a communication range of the Bluetooth® hands-free base;
identifying, by the Bluetooth® hands-free base, each of the plurality of Bluetooth® enabled phones within the communication range, each of the plurality of Bluetooth® enabled phones being identified by an identification information;
communicating, within the vehicle, the identification information for permitting a selection of one of the plurality of Bluetooth® enabled phones to be used in the hands-free system; and
selecting one of the plurality of Bluetooth® enabled phones to be connected to the hands-free system by selecting the identification information of one of the plurality of Bluetooth® enabled phones communicated.

26. The method of claim 25, wherein the communicating step further comprises:
displaying, by the Bluetooth® hands-free base, the identification information on a display screen.

27. The method of claim 25, wherein the communicating step further comprises:
communicating, through a speaker with the vehicle, the identification information.

28. The method of claim 25, wherein the selecting step further comprises:
displaying, by the Bluetooth® hands-free base, the identification information on a display screen; and
selecting, through a selection mechanism, the identification information corresponding to the one of the plurality of Bluetooth® enabled phones to be connected to the hands-free system.

29. The method of claim 28, wherein the selection mechanism is a button mechanism for selecting the identification information displayed on the screen for the Bluetooth® enabled phone to be selected.

30. The method of claim 28, wherein the selection mechanism is a scrolling mechanism for scrolling through the identification information for the plurality of Bluetooth® enabled phones.

31. The method of claim 25, further comprising:
identifying each of the plurality of Bluetooth® enabled phones within the communication range automatically upon entering the communication range;
displaying the identification information of the plurality of Bluetooth® enabled phones on a display screen;
scrolling, through a scrolling mechanism, the plurality of Bluetooth® enabled phones on the display screen to locate the identification information of one of the plurality of Bluetooth® enabled phones to be connected to the hands-free system; and
selecting, through a button mechanism, the identification information of the one of the plurality of Bluetooth® enabled phones to be connected to the hands-free system.

32. A computer-readable medium for storing instructions in a hands-free phone system of a vehicle, the hands-free phone system having a plurality of Bluetooth® enabled phones, a Bluetooth® hands-free base, a microphone to send voice communication to the Bluetooth® hands-free base and a speaker to receive voice communication from the Bluetooth® hands-free base, each of the Bluetooth® enabled phones being within a communication range of the Bluetooth® hands-free base, the computer-readable medium storing instructions for selecting one of the plurality of Bluetooth® enabled phones in the vehicle for use in the hands-free phone system, so that when the computer-readable medium is read by a computer system, the computer system performs the computer-effected steps of:
identifying, by the Bluetooth® hands-free base, each of the plurality of Bluetooth® enabled phones within the communication range, each of the plurality of Bluetooth® enabled phones being identified by an identification information;
communicating, within the vehicle, the identification information for permitting a selection of one of the plurality of Bluetooth® enabled phones to be used in the hands-free system; and
selecting one of the plurality of Bluetooth® enabled phones to be connected to the hands-free system by selecting the identification information of one of the plurality of Bluetooth® enabled phones communicated.

33. The computer readable medium of claim 32, wherein the computer system is the Bluetooth® hands-free base.

34. The computer readable medium of claim 32, wherein the computer system is a vehicle radio.

35. The computer readable medium of claim 32, wherein the computer system is a vehicle global positioning satellite navigation system.
